(19) United States
(12) Patent Application Publication
(10) Pub. No.: US 2024/0430347 A1
(43) Pub. Date: Dec. 26, 2024

(54) SELECTIVE QUIC DATAGRAM PAYLOAD RETRANSMISSION IN A NETWORK

(71) Applicant: TELEFONAKTIEBOLAGET LM ERICSSON (PUBL), Stockholm (SE)

(72) Inventors: Marcus IHLAR, ÄLVSJÖ (SE); Magnus WESTERLUND, Upplands Väsby (SE); Miguel Angel Muñoz De La Torre Alonso, Madrid (ES); Mirja KUEHLEWIND, Ludwigsburg (DE); Zaheduzzaman Sarker, Järfälla (SE)

(21) Appl. No.: 18/692,863

(22) PCT Filed: Oct. 18, 2021
(86) PCT No.: PCT/IB2021/059579

§ 371 Date: Mar. 18, 2024

(51) Int. Cl. H04L 69/16; H04L 12/14; H04L 65/1066

(52) U.S. Cl. CPC H04L 69/16; H04L 12/1407; H04L 65/1066

(57) ABSTRACT

Embodiments of the invention provide methods, apparatus, and media to perform selective QUIC datagram payload retransmission. In one embodiment, a method is performed by a proxy network device that is on a path between a first and a second peer network device. The method includes determining, for an end-to-end packet-based traffic flow between the first and second peer network devices, a first duration to perform traffic forwarding between the first peer network device and the proxy network device, and a second duration to perform traffic forwarding between the proxy network device and the second peer network device. The method further includes, based on the first and second durations, causing retransmission of an end-to-end packet embedded as a pay load of a QUIC datagram, where the end-to-end packet was previously transmitted between the first peer network device and the proxy network device.

### TECHNICAL FIELD

Embodiments of the invention relate to the field of networking; more specifically, to selective QUIC datagram payload retransmission in a telecommunications network.

### BACKGROUND ART

QUIC is a general-purpose transport layer network protocol. While it may be referred to as the acronym for Quick User Datagram Protocol (UDP) Internet Connections, some organizations (e.g., Internet Engineering Task Force, IETF) refer to QUIC as the name of the protocol without treating it as an acronym. QUIC may be viewed as similar to Transmission Control Protocol (TCP)+enhancement such as Transport Layer Security (TLS) and/or Hypertext Transfer Protocol 2.0 (HTTP/2 or HTTP/2.0) but implemented on UDP. QUIC is a UDP based secure transport protocol with integrity protected header and encrypted payload. Yet unlike the traditional transport protocol stack with Transmission Control Protocol (TCP), which resides in the operating system kernel, QUIC can easily be implemented in user space (e.g., the application layer). Consequently, this improves flexibility in terms of transport protocol evolution with implementation of new features, congestion control, the ability to deploy, and adoption.

QUIC may be implemented in a network where a proxy is used between two peer nodes (e.g., a server and a client) to transmit datagrams. The proxy may retransmit packets lost on the link between the proxy and a peer node (sometimes referred to as local recovery/retransmission) in several ways, for example, through reliable stream-based encapsulation and/or unreliable QUIC datagram retransmission. End-to-end transport flows through connections such as QUIC or TCP connections may also implement retransmission between the two peer nodes (sometimes referred to as end-to-end recovery/retransmission).

### SUMMARY

Embodiments of the invention disclose methods, apparatus, and media to perform selective QUIC datagram payload retransmission in a telecommunications network. In one embodiment, a method is performed by a proxy network device that is on a path between a first peer network device and a second peer network device. The method includes determining, for an end-to-end packet-based traffic flow between the first and second peer network devices, a first duration to perform traffic forwarding between the first peer network device and the proxy network device, and a second duration to perform traffic forwarding between the proxy network device and the second peer network device. The method further includes, based on the first and second durations, causing retransmission of an end-to-end packet within the end-to-end packet-based traffic flow, wherein the end-to-end packet is embedded as a payload of a QUIC datagram, where the end-to-end packet was previously transmitted between the first peer network device and the proxy network device, and where the retransmission of the end-to-end packet is between the first peer network device and the proxy network device.

In one embodiment, a proxy network device is disclosed to perform selective QUIC datagram payload retransmission in a telecommunications network. The proxy network device comprises a processor and machine-readable storage medium coupled to the processor, where the machine-readable storage medium stores instructions, which when executed by the processor, are capable to perform determining, for an end-to-end packet-based traffic flow between the first and second peer network devices, a first duration to perform traffic forwarding between the first peer network device and the proxy network device, and a second duration to perform traffic forwarding between the proxy network device and the second peer network device. The instructions, when executed by the processor, are capable to further perform, based on the first and second durations, causing retransmission of an end-to-end packet within the end-to-end packet-based traffic flow, wherein the end-to-end packet is embedded as a payload of a QUIC datagram, where the end-to-end packet was previously transmitted between the first peer network device and the proxy network device, and where the retransmission of the end-to-end packet is between the first peer network device and the proxy network device.

In one embodiment, a machine-readable storage medium is disclosed to perform selective QUIC datagram payload retransmission in a telecommunications network. The machine-readable storage medium is coupled to a processor, where the machine-readable storage medium stores instructions, which when executed by the processor, are capable to perform determining, for an end-to-end packet-based traffic flow between the first and second peer network devices, a first duration to perform traffic forwarding between the first peer network device and the proxy network device, and a second duration to perform traffic forwarding between the proxy network device and the second peer network device. The instructions when executed by the processor, are capable to further perform, based on the first and second durations, causing retransmission of an end-to-end packet within the end-to-end packet-based traffic flow, where the end-to-end packet is embedded as a payload of a QUIC datagram, where the end-to-end packet was previously transmitted between the first peer network device and the proxy network device, and where the retransmission of the end-to-end packet is between the first peer network device and the proxy network device.

Embodiments of the invention use a proxy-based retransmission mechanism, and the transmission of QUIC datagrams to recover the lost end-to-end packets in the QUIC datagram forwarding segment may incur less per-packet overhead, and it avoids the head-of-line blocking that would incur if a QUIC stream-based service is used. The transmission of QUIC datagrams locally also enables selective local retransmission that can be optimized based on delay measurements, characteristics of application/end-to-end traffic flow, and network conditions.

### BRIEF DESCRIPTION OF THE DRAWINGS

The invention may best be understood by referring to the following description and accompanying drawings that are used to illustrate embodiments of the invention. In the drawings:

FIG. 1 illustrates proxied datagram retransmission in a wireless network per some embodiments.

FIG. 2 illustrates datagram encapsulation and delay measurement in an end-to-end packet-based traffic flow per some embodiments.

FIG. 3 illustrates weighing the factors to perform local retransmission for an end-to-end packet-based traffic flow per some embodiments.

FIG. 4 illustrates the 5G reference architecture as defined by 3GPP (the third Generation Partnership Project).

FIGS. 5A-5C illustrate enabling local retransmission service using a Policy and Charging Control (PCC) rule per some embodiments.

FIG. 6 is a flow diagram illustrating the operation flow of proxied datagram retransmission in a wireless network per some embodiments.

FIG. 7A illustrates connectivity between network devices (NDs) within an

exemplary network, as well as three exemplary implementations of the NDs, according to some embodiments of the invention.

FIG. 7B illustrates an exemplary way to implement a special-purpose network device according to some embodiments of the invention.

FIG. 7C illustrates various exemplary ways in which VNEs may be coupled according to some embodiments of the invention.

FIG. 7D illustrates a network with a single network element on each of the NDs of FIG. 7A, and within this straightforward approach contrasts a traditional distributed approach (commonly used by traditional routers) with a centralized approach for maintaining reachability and forwarding information (also called network control), according to some embodiments of the invention.

FIG. 7E illustrates the simple case of where each of the NDs implements a single NE, but a centralized control plane has abstracted multiple of the NEs in different NDs into (to represent) a single NE in one of the virtual network(s), according to some embodiments of the invention.

FIG. 7F illustrates a case where multiple VNEs are implemented on different NDs and are coupled to each other, and where a centralized control plane has abstracted these multiple VNEs such that they appear as a single VNE within one of the virtual networks, according to some embodiments of the invention

### DETAILED DESCRIPTION

The following description describes methods and apparatus for a proxy node to use datagram-based encapsulation of end-to-end traffic to selectively perform lost recovery of packets. The decision whether to buffer and retransmit end-to-end packets in an end-to-end packet-based traffic flow can be determined by a combination of measurements of network conditions and policies related to the type of end-to-end packet-based traffic flow that is being proxied.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

In the following description, numerous specific details such as logic implementations, opcodes, means to specify operands, resource partitioning/sharing/duplication implementations, types and interrelationships of system components, and logic partitioning/integration choices are set forth to provide a more thorough understanding of the present invention. It will be appreciated, however, by one skilled in the art that the invention may be practiced without such specific details. In other instances, control structures, gate level circuits, and full software instruction sequences have not been shown in detail in order not to obscure the invention. Those of ordinary skill in the art, with the included descriptions, will be able to implement appropriate functionality without undue experimentation.

### QUIC and Datagram Transmission

While QUIC standardization efforts started a few years ago, presently it represents nearly 10% of the Internet traffic pushed by large Internet domains. QUIC is becoming a main transport protocol in the Internet's user plane. Many applications running today over HTTP/HTTPS (Hypertext Transfer Protocol Secure) may migrate to QUIC, driven by QUIC's latency improvements and stronger security. QUIC may use TLS for security handshake. TLS exchanges the necessary keying material in the protocol's handshake. The use of TLS or Datagram TLS (DTLS), defined in standards such as Internet Engineering Task Force (IETF) Request for Comments (RFC) 8446, is very common as a transport security solution independent from the transport protocol being TCP or UDP. The encryption in QUIC covers both the transport protocol headers as well as the payload, as opposed to TLS over TCP (e.g., HTTPS), which protects only the payload. Note that HTTP-over-QUIC is sometimes referred to as HTTP/3 as approved by IETF.

In QUIC, the payload protection uses the unencrypted packet number as input to the cryptographic algorithm. Therefore, the QUIC payload is protected using a key separated from what is used for header protection. The key used for header protection is called the header protection key.

QUIC is designed to provide reliable data transfer like TCP. A sender keeps track of outstanding data and retransmits data that is determined to be lost. A receiver sends acknowledgements of received packets to help the sender determine the delivery status. Other than TCP, however, QUIC defines a logical separation of transmitted data into streams, where only within a stream does data need to be delivered to an application in-order. There is no required ordering of delivery between separate streams, thus avoiding delaying independent data, something that TCP may incur.

QUIC also supports an extension for transmission of datagrams. In contrast to streams, there is no requirement of datagrams being delivered in a specific order, and QUIC senders will not retransmit datagrams that are deemed lost. In contrast to pure UDP datagrams, QUIC datagrams are delivered within a congestion-controlled connection. This means that receivers need to send acknowledgements upon receiving datagrams.

Proxy & Enhancement Entities

A proxy is an intermediary program/software (or hardware such as a network node implementing such intermediary program/software) acting as a server, a client, or a combination of the server or client for some functionalities as the proxy may create or simply relay requests on behalf of other entities. The proxy may be implemented on a path between a server and a client. Note that each of the client, server, and proxy may be implemented in one or more network devices (also referred to as network nodes) such as client network devices, server network devices, and proxy network devices, respectively. Each of a server or client may be referred to as an endpoint node, and the proxy may be referred to as an intermediate (on-path) node. Requests from the client are serviced internally by the server or by passing them on, with possible translation, to other servers.

There are several types of proxies, including the following: (1) A “transparent proxy” is a proxy that does not modify the request or response beyond what is required for proxy authentication and identification; (2) A “non-transparent proxy” is a proxy that modifies the request or response to provide some added service to the user agent, such as group annotation services, media type transformation, protocol reduction, or anonymity filtering; (3) A “reverse proxy” basically is a proxy that pretends to be the actual server (as far as any client or client proxy is concerned), but it passes on the request to the actual server that is usually sitting behind another layer of firewalls; and (4) A “performance enhancement proxy” (PEP) is used to improve the performance of protocols on network paths where native performance suffers due to characteristics of a link or subnetwork on the path.

A proxy may implement a Collaborative Performance Enhancement (COPE) node or function, which is an entity that resides between two endpoints, usually in a client and server setup but also in a peer-to-peer communication setup, that use encrypted communication. The communicating parties (usually the client) may, where the server is otherwise not directly reachable, explicitly contact the COPE node/function in order to request a network-support service. This service at a minimum always includes forwarding of the encrypted traffic to a specific server. In addition, the endpoints can share traffic information with the COPE entity such that the COPE entity can execute a requested performance enhancement function to improve the quality of service (QOS) of the traffic as well as optimize operations within the network. In addition or in alternative, the COPE node can provide additional information about the network that enables the endpoint to optimize its data transfer, e.g., use a more optimized congestion control or delay pre-fetching activities. In addition or in alternative, a proxy may enable proxy services by extending HTTP connect method for UDP using Multiplexed Application Substrate over QUIC Encryption (MASQUE). Note that the proxy discussed herein relates to QUIC protocol, and they may be referred to as QUIC proxy, and the terms “proxy” and “QUIC proxy” are used interchangeably unless otherwise noted.

### Proxied Datagram Retransmission

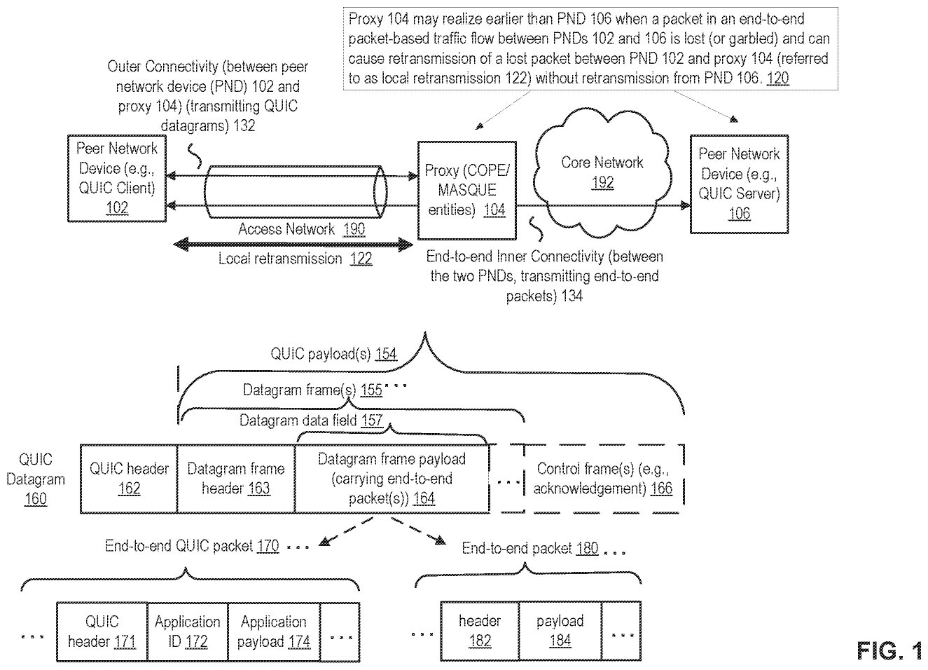

FIG. 1 illustrates proxied datagram retransmission in a wireless network per some embodiments. The communication is between two peer network devices (PNDs) 102 and 106. A non-limiting example of two peer network devices is one being a client (e.g., a QUIC client) at the peer network device 102, and the other being a server (e.g., a QUIC server) at the peer network device 106. The peer network device 102 may learn about the existence of the proxy 104 either directly from an access network 190 or by another communication with the peer network device 106. The proxy 104 may provide one or more enhancement functions between the peer network devices 102 and 106. The proxy 104 may be implemented in a network device.

When the proxy 104 is detected, the peer network device 102 may open a connection to the proxy 104. For example, when QUIC is used as the transport protocol, a QUIC connection is opened to request a service. The QUIC connection between the peer network device 102 and proxy 104 uses an outer connection 132 and can exchange information through that outer QUIC connection (e.g., through QUIC datagrams such as QUIC datagram 160). The communication with the peer network device 106 (e.g., a QUIC server) is realized by an inner transport connection 134 that forwards end-to-end packets and that is encrypted end-to-end between the peer network devices 102 and 106 through a core network 192. The inner transport connection is sent within the outer QUIC connection.

The end-to-end communication between the peer network devices 102 and 106 may be through end-to-end packets in a traffic flow (also referred as flow). The end-to-end packets are embedded in QUIC datagrams when forwarded between the peer network device 102 and proxy 104. A QUIC datagram is a QUIC packet containing one or more datagram frames. For example, a QUIC datagram 160 includes a QUIC header 162, one or more QUIC datagram frames 155 and optionally one or more control frames 166. A QUIC datagram frame 155 includes a datagram frame header 163 and datagram data field 157. The datagram frame header 163 may optionally include a length field to indicate the length of the datagram frame and thus support the case when there are multiple datagram frames or other QUIC frames such as control frames 166 inside the QUIC datagram 160. The one or more control frames 166 are implemented for maintenance and management and they may be forwarded along with datagram frames or stream frames in a QUIC packet. Note that QUIC stream frames provide an in-order reliable delivery, and if used to forward a flow of end-to-end packets, these packets will be forwarded by a tunnel (e.g., between two endpoints through a proxy) in the order they were sent. The forwarding of the end-to-end traffic flow in QUIC datagrams between the peer network devices 102 and 106 does not require packet forwarding to follow a strict order as received (unlike a traffic flow using stream frames), and the end-to-end traffic flow is referred to as an end-to-end packet-based traffic flow.

Within a QUIC datagram 160, an embedded QUIC datagram payload 164 may carry one or more end-to-end packets as shown at references 170 and 180. The QUIC datagram payload 164 may include an additional header for the HTTP layer before the end-to-end packets 170 and 180 (not shown). As illustrated, the embedded QUIC datagram payload 164 includes an end-to-end QUIC packet 170 (with source/destination being the peer network devices 102 and 106). The end-to-end QUIC packet 170 includes a QUIC header 171, and its QUIC payload may include an application identifier (ID) 172 and the corresponding application payload 174. Optionally, the QUIC payload may contain other QUIC frames and control data (the control data may include the application ID that is inserted during the QUIC handshake). Alternatively, the QUIC datagram payload may include another end-to-end packet 180 (either a QUIC packet or not) that does not include the application specific information. Note that when the application ID is not included, the corresponding application and application ID (application information) may be inferred by the peer network devices 102 and 106 or the proxy 104 based on the established inner or outer transport connection, or the information in the management system of the wireless network. Each QUIC datagram may include (1) one or more QUIC datagram payloads that include application information such as the one shown at reference 170 (and in some embodiments, the end-to-end packet is not a QUIC packet but still includes the application information), or (2) one or more end-to-end packets without application information such as the one shown at reference 180.

In some embodiments, the proxy 104 implements a COPE node and/or function (COPE) entity. The proxy 104 may also use MASQUE protocol to set up connections with the peer network device 102, and such implementation may be referred to as a MASQUE entity. By using enhancement entities such as COPE and MASQUE, the proxy 104 may enhance the communication between the peer network devices 102 and 106.

The proxy 104 (e.g., MASQUE-based and/or COPE-based) uses QUIC to encapsulate the proxied traffic, and the encapsulation of the end-to-end traffic may be within a datagram flow (instead of stream flow). While a datagram flow does not deliver packets in the flow in a specific order as a stream flow, such encapsulation is beneficial as it reduces overhead both in packet size and processing, and it additionally removes issues with head-of-line blocking associated with stream-based encapsulation.

Yet if the proxy 104 is to provide local retransmission (also referred to as local loss recovery or local repair) as an optimization service, it cannot rely on the underlying QUIC protocol implementation to recover lost packets when QUIC datagrams are used since QUIC datagrams are unreliable. QUIC datagrams are unreliable because, unlike a sender of the QUIC stream frames, a sender of the QUIC datagram frames does not maintain a retransmission buffer of the transmitted payload, and a receiver of the QUIC datagram frames does not buffer received out-of-order payload and adjust the order to make the payload be delivered in order to an application. A proxy that aims to repair packets lost on the link between the peer network device and the proxy could use reliable stream-based encapsulation instead. However, using stream-based encapsulation increases the per-packet overhead, introduces head of line blocking for the encapsulated flow and, moreover, it implies that the proxy relies on the use of the retransmission behavior of the underlying QUIC connection without the ability to make selective decisions based on local network knowledge. To overcome the drawbacks of the stream-based encapsulation in local retransmission, embodiments of the invention use datagram-based encapsulation of end-to-end traffic at the proxy 104 to selectively perform loss recovery of QUIC packets.

The proxy 104 monitors QUIC datagrams (including one or more end-to-end packets as QUIC datagram payload) that it transmits to the peer network device 102, and if no response is received or a response is received indicating that a transmitted QUIC datagram is lost, the proxy 104 may transmit a QUIC datagram with the QUIC datagram payload (including one or more end-to-end packets) that was lost. Alternatively, the proxy 104 may anticipate a QUIC datagram from the peer network device 102 in an end-to-end traffic flow, and when such QUIC datagram fails to arrive or the QUIC datagram arrives but is garbled or otherwise its QUIC datagram payload cannot be processed properly at the proxy 104, the proxy 104 may require the peer network device 102 to retransmit a QUIC datagram that includes the end-to-end packets that were transmitted earlier within the QUIC datagram that cannot be processed properly at the proxy 104. Such retransmission between the peer network device 102 and proxy 104, either from the peer network device 102 to the proxy 104 (also referred to as forward direction herein) or from the proxy 104 to the peer network device 102 (also referred to as backward direction herein), is shown at reference 122 and referred to as local retransmission, as it does not involve end-to-end retransmission of the end-to-end packet between the peer network devices 102 and 106.

Local retransmission of a QUIC packet may be faster than end-to-end retransmission of the QUIC packet since the proxy 104 is closer to the peer network device 102 than the peer network device 106, and the proxy 104 may realize that the QUIC packet is lost sooner than the peer network device 106 as explained at reference 120. Thus, local retransmission may be more efficient than end-to-end retransmission in a proxied end-to-end packet-based traffic flow.

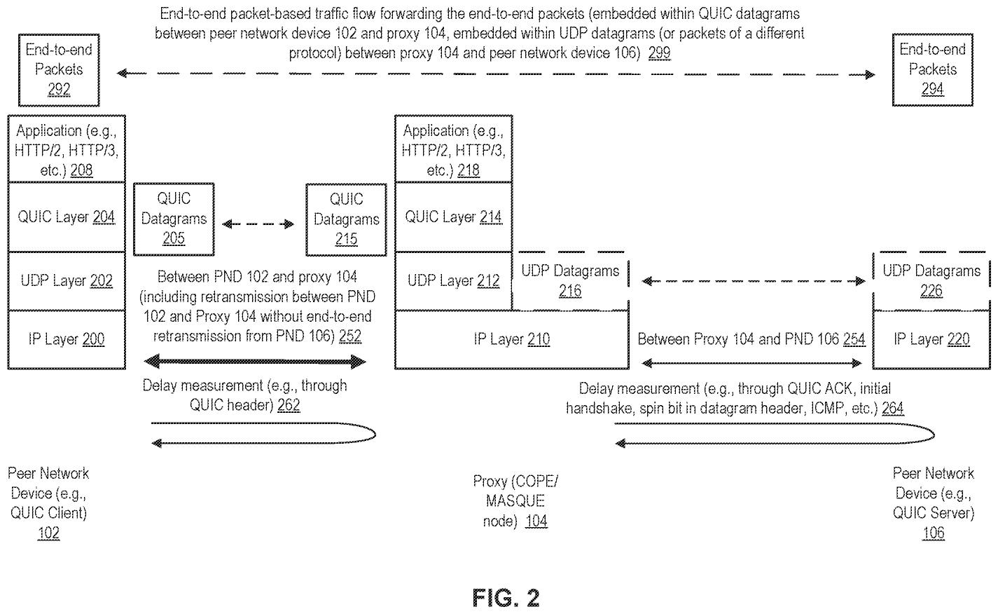

The proxy 104 may implement a proxy application that uses an underlying QUIC connection to a client. FIG. 2 illustrates datagram encapsulation and delay measurement in an end-to-end packet-based traffic flow per some embodiments. The same peer network devices 102 and 106, and proxy 104 are shown with the abstraction layers for QUIC datagram delivery in an end-to-end packet-based traffic flow. Traffic flows are delivered through UDP over Internet Protocol (IP) (instead of TCP/IP), thus each of the peer network devices 102 and 106, and proxy 104 maintains their respective IP layers. At the peer network device 102, the end-to-end packets 292 are formed with data coming from application 208 (which may form an application layer). These end-to-end packets 292 are QUIC packets in some embodiments. The application may be HTTP/2, HTTP/3, or any other application for which packets are generated for an end-to-end traffic flow to the peer network device 106. The application may also include one that interacts with a peer application 218 at the proxy 104 for establishing and maintaining the outer connection 132 discussed herein above.

The end-to-end packets 292 are included in QUIC datagrams 205 at the QUIC layer 204 as QUIC datagram payloads such as the datagram payload 164 in FIG. 1. The newly formed QUIC datagrams are then transmitted through further encapsulation at the UDP and IP layers (at references 202 and 200) and reach the proxy 104. Then encapsulated traffic is forwarded through the one or more links 252 between the peer network device 102 and proxy 104, and the links form the first peer-proxy segment (also referred to as leg or section) of the end-to-end connection. Once the encapsulated traffic reaches the proxy 104, the proxy 104 decapsulates and obtains the QUIC datagrams (now referred to as QUIC datagram 215) at the QUIC layer 214. The end-to-end packets included in the QUIC datagrams may then be extracted and transmitted toward the peer network device 106. In some embodiments, the end-to-end packets are transmitted as raw UDP datagrams 216 through the one or more links 254 between the proxy 104 and peer network device 106, and the links form the proxy-second peer segment of the end-to-end connection. Once the raw UDP datagrams arrive at the peer network device 106, the peer network device 106 decapsulates and obtains the end-to-end packets in the raw UDP datagrams (now referred to as UDP datagram 226). Similarly, the end-to-end packets 294 may be forwarded from the peer network device 106 to the peer network device 102 in the reverse direction. In other embodiments, the end-to-end packets are transmitted through different protocol (e.g., included as payloads of TCP packets or IP packets).

Thus, the end-to-end packet-based traffic flow is forwarded using the tunneled end-to-end packets through encapsulation in datagrams, which are transmitted by the QUIC connection in an unreliable fashion as explained at reference 299. Note that the end-to-end packets are transmitted end-to-end, the carriers/packets in which the end-to-end packets are embedded as payloads may differ in the different segments of the end-to-end connection-for example, the carrier being QUIC datagrams in the first peer-proxy segment and UDP datagrams (or another carrier) in the proxy-second peer segment.

The proxy 104 may implement a proxy application over the QUIC layer in some embodiments. The QUIC layer does not store data in a retransmission buffer of the proxy 104 in some embodiments, yet it does remember which QUIC datagrams have been sent and tracks when those QUIC datagrams get acknowledged or otherwise lost. In some embodiments, the proxy application has an interface to the underlying QUIC connection so that it can keep track of the delivery status of transmitted datagrams.

In some embodiments, the proxy application maintains a retransmission buffer of packets it has written to the QUIC layer. The proxy application maintains a set of local retransmission rules per end-to-end connection that is based on a combination of policy and network conditions. A QUIC datagram that is determined to be lost can be retransmitted by writing it to the QUIC layer.

References 262 and 264 show delay measurement at links 252 and 254 for forwarding traffic. One common measurement of traffic forwarding delay is the round-trip time (RTT). Through measuring multiple RTTs, the delay at the links 252 and 254 can be determined. For example, a first RTT (shown at reference 262) can be the time period for a packet/datagram from being transmitted at the peer network device 102 toward the proxy 104 to the response of the transmission from the proxy 104 being received at the peer network device 102. The time delay for the links 252 will be half of the first RTT. A second RTT (shown at reference 264) can be the time period for a packet/datagram from being transmitted at the proxy 104 toward the peer network device 106 to the response of the transmission from the peer network device 106 being received at the proxy 104. The time delay for the links 254 will be half of the second RTT. Other RTTs can be used to determine the time delay as well, such as ones from sending a packet and receiving a response of it, from the peer network device 106 toward the proxy 104, from the peer network devices 106 to 102, or from the proxy 104 to the peer network device 102. Note that the traffic forwarding delay is the period to perform traffic forwarding between two endpoints, and it may include the propagation delay and processing delay at the links coupled to two endpoints of a connection and the endpoints themselves, and to determine local retransmission rules, a proxy does not need to differentiate the types of delay contributed to the traffic forwarding delay.

Additionally, different protocols may be used to measure the delay at links for forwarding traffic as well. For example, the RTT at reference 262 between the peer network device 102 and proxy 104 is continuously estimated by the QUIC layer and can be exposed to the proxy application. Such determination of the RTT is straightforward through datagram acknowledgement in the QUIC layer through the QUIC headers of the QUIC datagrams, QUIC packets carrying stream frames or control frames. If data between the proxy 104 and the peer network device 106 is encapsulated in QUIC datagrams, that RTT at reference 264 can be continuously estimated by the QUIC layer as well.

However, the more common case is that the proxy 104 forwards to and receives data from the peer network device 106 as raw UDP datagrams (or carriers/packets in another protocol) on the proxy-second peer segment (as shown at FIG. 2). In that case an initial RTT sample can be obtained by measuring the time from forwarding the initial handshake packet from the peer network device 102 until observing the initial handshake response from the peer network device 106. In some embodiments, it is sufficient to use the initial RTT estimate as the delay measure to decide if proxy retransmissions are beneficial.

Additionally, if the end-to-end connection is exposing the RTT by use of the spin-bit in the QUIC header or similar mechanism, that can be used to continuously obtain RTT estimates throughout the lifetime of the connection. Furthermore, periodic transmission of Internet Control Message Protocol (ICMP) Echo messages could be used to measure the RTT between the proxy 104 and peer network device 106 if the ICMP Echo responses are received. Also, in some embodiments, prior measurements of another end-to-end packet-based traffic flow may be used as an estimate of the RTT for the present traffic flow.

While references 262 and 264 shows several ways to measure the delay (specifically measuring RTTs), embodiments of the invention are not so limited, and the delay at links for forwarding traffic may be measured not through the RTTs, and other ways to measure the RTTs and/or the delay of traffic forwarding at (1) first peer-proxy segment and (2) the proxy-second peer segment are feasible as well.

Once the delay measurements of different segments are determined, the proxy 104 can selectively enable local retransmission through the proxy application when the local retransmission provides better performance for an end-to-end packet-based traffic flow. To determine whether to enable the local retransmission, a variety of factors may be weighed.

### Weigh on Cost and Benefit of Local Retransmission

The factors to consider about enabling local retransmission in a proxied end-to-end packet-based traffic flow forwarding can be numerous, and they are related to delay measurements, the underlying characteristics of the traffic flow, and/or network conditions.

### Delay Measurements

The proxy 104 can selectively enable loss recovery through the proxy application if it is deemed to provide a performance benefit to the receiving flow. The closer the proxy 104 is to the peer network device 102 relative to the peer network device 106, the more beneficial the loss recovery becomes. By measuring delay between the peer network device 102 and the proxy 104 (at links 252), and the delay between the proxy 104 and the peer network device 106 (at links 254), the proxy 104 can decide whether the relative distance to the endpoints is within the range where loss recovery is beneficial or not. Proxy retransmissions are most effective if they can be performed such that the peer network device 106 has not yet detected that the original data from the peer network device 102 was lost.

### The Underlying Characteristics of the Traffic Flow/Application

The end-to-end packet-based traffic flow may be one for a particular application (e.g., application 208), and the application may require a specific quality of service (QOS) and/or comply with a specific service level agreement (SLA). For example, if an application has real-time or semi real-time properties especially with more stringent end-to-end latency requirements, local retransmissions have a potential of improving the experience of the application. In contrast, an application having a large bulk download requiring best effort only may benefit less in terms of user experience.

The application may be identified using an application ID. The application ID may be embedded within the end-to-end packets (e.g., the end-to-end QUIC packet 170) prior to when the datagram frame payload is formed. For example, the application ID may be inserted in an end-to-end QUIC packet during the QUIC handshake procedure. It may be inserted by the client before the end-to-end QUIC packet is encapsulated in a datagram. QUIC handshake packets have fields that are visible to the proxy, so the proxy can access that application ID even though it is part of the end-to-end QUIC packet.

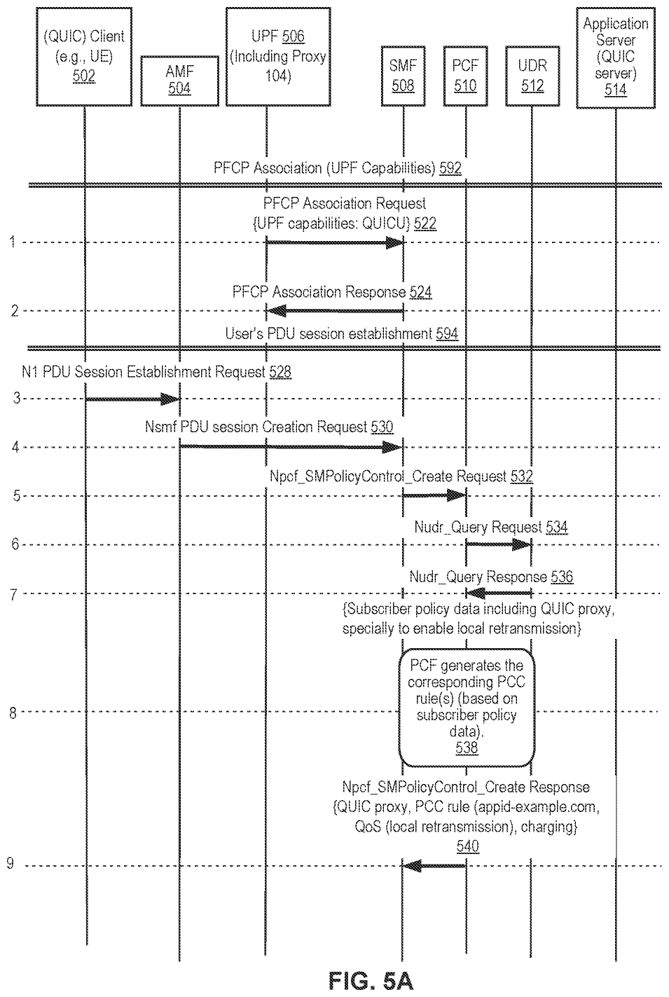

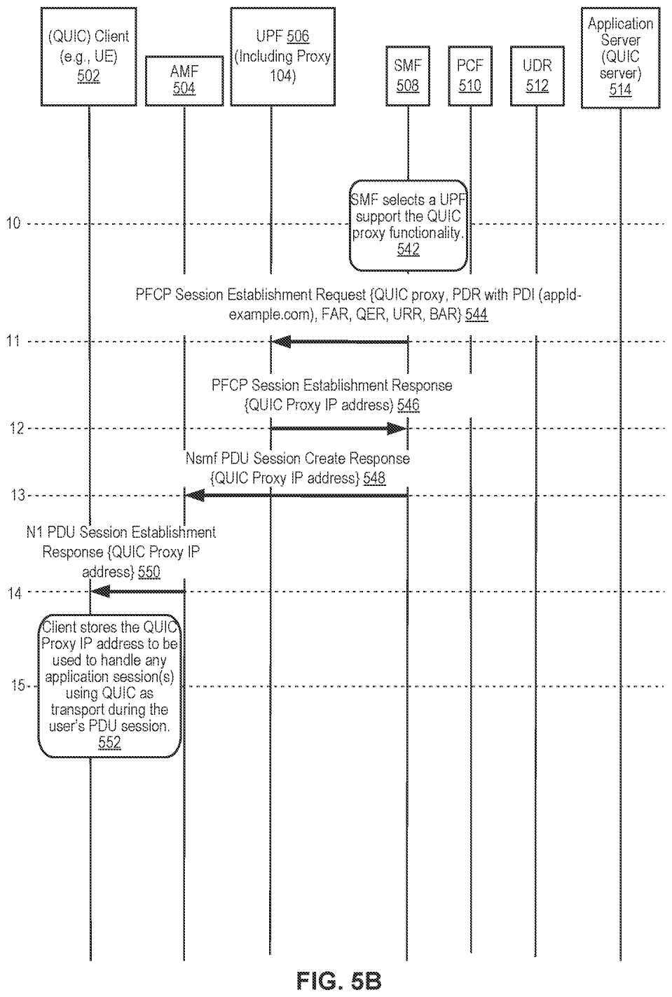

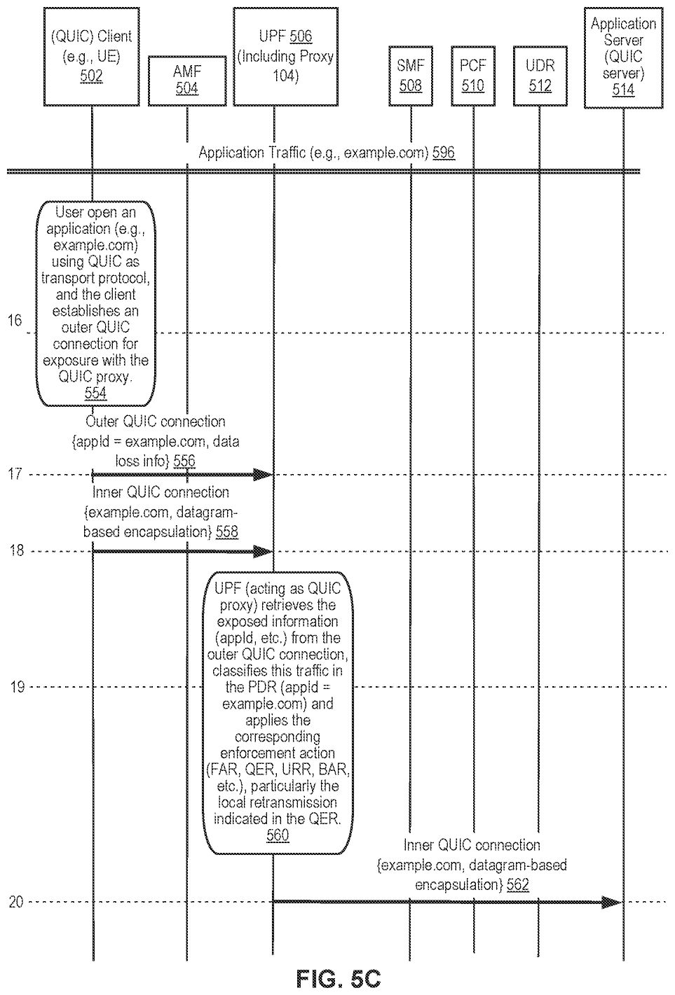

The application ID is provided by the application in some embodiments. In addition or in alternative, the application ID may be determined from the tunnel establishment or based on information in the management system in the wireless network. Based on the characteristics of the traffic flow (which is identified by the application ID in some embodiments), a proxy may decide a local retransmission rule, e.g., local retransmission for an application having real-time or semi real-time properties but no local retransmission for an application having the large bulk download. The local retransmission rules can go beyond the retransmission on/off decision-the proxy may determine for the application, what is the acceptable data rate, the acceptable packet loss rate, the corresponding thresholds to trigger or stop local retransmission between the link(s) that QUIC datagrams are forwarded (e.g., between the peer network device 102 and proxy 104). By being aware of the application mapping to an end-to-end packet-based traffic flow, a proxy may selectively perform local retransmission on the packets of the end-to-end packet-based traffic flow so that the application benefits sufficiently from the local retransmission, and such application awareness thus improves the efficiency of the retransmission. The application ID may also be used to enforce a set of retransmission rules, such as PCC rules as discussed herein in further details relating to FIGS. 5A-5C.

### Network Conditions

A proxy may use awareness of the expected properties of the access network it serves to determine the likelihood of experiencing traffic drops. A historical count of data (datagram/packet) loss rates for a user or path can also be maintained. A combination of such parameters can be used as input to the local retransmission rules of the proxy. The proxy can decide to maintain a retransmission buffer and the size of that buffer based on the projected loss rate, RTT, and expected maximum data rate. If losses are sparse on the link(s) that QUIC datagrams are forwarded (e.g., between the peer network device 102 and proxy 104), the additional effort of local buffering might not justify the benefit. However, with higher loss rates, benefits and performance improvements can be significant to perform the local retransmission.

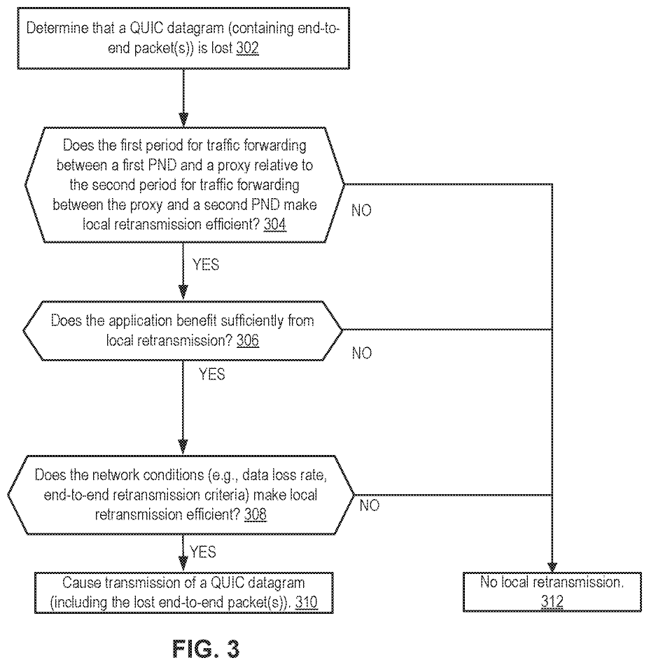

FIG. 3 illustrates weighing the factors to perform local retransmission for an end-to-end packet-based traffic flow per some embodiments. The operations are performed by a proxy such as the proxy 104 that is implemented between two peer network devices such as the peer network devices 102 and 106.

At reference 302, the proxy determines that a QUIC datagram that includes one or more end-to-end packets to be forwarded between two peer network devices is lost. The determination may be based on a notification by a peer network device (e.g., peer network device 102), in which case the proxy is to perform the local retransmission of another QUIC datagram to include the lost end-to-end packets. The determination may be based on local detection of the QUIC datagram being garbled or not being received as expected, in which case a potential local retransmission will be performed by the QUIC datagram transmitting peer network device such as the peer network device 102.

At reference 304, the proxy determines whether the first period for traffic forwarding between a first peer network device and the proxy (the QUIC datagram forwarding segment) relative to the second period for traffic forwarding between the proxy and a second network device (the segment forwarding another datagram (although QUIC datagram is possible in some embodiments)) is such that the local retransmission is efficient. The proxy may compare the ratio of the periods (delay measurements) to a threshold to decide whether to perform local retransmission. In general, the lower the ratio of the first period to the second period, the more efficient is the local retransmission, since the low ratio indicates that the proxy is close to the first peer network device.

At reference 306, the proxy determines whether the application benefits sufficiently from local retransmission. As discussed herein above, the application awareness may determine whether to perform local retransmission or not (an on/off decision) or perform local retransmission for the application at certain conditions (which corresponding thresholds are measured against).

At reference 308, the proxy determines whether the network condition makes local retransmission efficient. The network condition includes data (packet/datagram) loss rate of the link(s) on which QUIC datagrams are forwarded. The network condition may also include the end-to-end retransmission criteria as discussed herein below.

If the result of any of the determinations is negative, no local retransmission is performed as shown at reference 312; otherwise, the proxy causes transmission of a QUIC datagram including the lost one or more end-to-end packets at reference 310. Note the determination of the network condition includes the end-to-end retransmission criteria, and that criteria are discussed in the next section.

Local retransmission and end-to-end retransmission

For a proxied end-to-end packet-based traffic flow as the ones shown in FIGS. 1 and 2, a lost end-to-end packet may be obtained by local retransmission in the QUIC datagram forwarding segment (e.g., between the peer network device 102 and proxy 104) or end-to-end retransmission (e.g., between the peer network devices 102 and 106). The latter may be triggered by, for example, the receiving peer network device 102 that detects the loss of the end-to-end packet and reports back to the transmitting peer network device 106, which is triggered to retransmit end-to-end (and the end-to-end retransmission can be performed in the reverse direction as well).

To prevent such reports, the local retransmission in the QUIC datagram forwarding segment needs to occur prior to the transmitting peer network device being notified of the loss of the end-to-end packet. That can be hard to achieve unless explicit signaling between the receiving peer network device and proxy is present so that the receiving peer network device knows that local retransmission will occur and knows also how persistent the proxy will be in attempting to retransmit a datagram lost in the QUIC datagram forwarding segment.

Even if the lost end-to-end packet is going to be retransmitted end-to-end, the local retransmission may still be a significant gain for an application, as the total latency from a local retransmission is significantly lower than the end-to-end retransmission. However, this comes at a cost of increased resource utilization in the form of multiple copies of the same data passing in the QUIC datagram forwarding segment.

There are several reasons why in most cases the number of local retransmission attempts should be kept low, for example:

(1) To maximize efficiency. The persistence of local retransmission should not be such that there is only a small-time gain, if any at all, between the local retransmission and the end-to-end retransmission. Thus, a local retransmission attempt period may be set to be within a single end-to-end delay period. For example, when the first local retransmission attempt fails, the proxy may cause further local retransmission attempts, and the duration of such local retransmission attempts should not exceed the end-to-end delay period, since by then the other peer network device (e.g., peer network device 106) would be notified about the packet loss and initiate an end-to-end retransmission. The duration of the local retransmission attempts is the time it takes to (i) detect the end-to-end packet loss and (ii) perform one or more local retransmissions. The time period to detect the end-to-end packet loss is a lapse of time since the end-to-end packet is determined to be in need of retransmission (e.g., when the end-to-end packet is lost or garbled).

(2) To minimize impact on the end-to-end traffic flow's recovery and congestion control. Local loss in the QUIC datagram forwarding segment that is repaired after several attempts will appear to the end-to-end traffic flow as severely out of order. This can, depending on the congestion controller, also trigger a congestion response.

(3) To limit consumption of buffer memory. The longer traffic forwarding delay, the more the buffer memory is required to perform local retransmission. The higher the number of local retransmission attempts are set, and the higher the data rate, the more the buffer memory is needed. While the memory space for an acknowledged datagram is released quickly, the constant maintenance of large buffer memory due to a high number of local retransmission attempts can be costly.

With these and other considerations, a proxy needs to determine whether to perform local retransmission and what is a reasonable number of retransmission attempts. Using a scenario where the peer network devices are a client and a server, and the traffic forwarding delay is measured using round-trip time (RTT), one may make decisions using the following input round-trip time (RTT) parameters: (1) the proxy to client RTT (RTTpc); (2) the server to proxy RTT (RTTsp); (3) the loss rate (Lpc) on the proxy to the client path, which is the QUIC datagram forwarding segment; (4) the proxy loss detection time (Tp); and (5) the end-to-end loss detection time (Ts). The proxy/end-to-end loss detection time can be obtained in a variety of ways. For example, the proxy may count multiple acknowledgements, where if multiple acknowledgements are received and the lowest acknowledgement number is not increased, the corresponding datagram is lost. Also, the proxy may set a transmission/retransmission timeout timer to detect the traffic loss (e.g., detecting a loss upon the timeout expires without an acknowledgement). The proxy may pre-determine a loss detection time (Tp), which is the wait time after receiving a previous datagram of the end-to-end traffic flow (e.g., identified by application ID), and not receiving a further datagram of the end-to-end traffic flow after the loss detection time causes the proxy to detect a datagram loss. Note that the proxy may not be able to accurately measure the end-to-end loss detection time for the server, but it may estimate T's based on its loss detection or inspect the passthrough packets between the client and server.

Using the values of these input parameters, the proxy may determine which of the following scenarios apply in determining whether to perform local retransmission versus rely on end-to-end retransmission:

(1) No end-to-end retransmission, only local retransmission: when loss detection and local retransmission are completed in the QUIC datagram forwarding segment (by either the proxy or client) before the server detects the loss, which happens when RTTpc+Tp<RTTpc/2+RTTsp/2+Ts. The left side of the formula shows the time period of the local retransmission (by the proxy or the client) being the sum of (1) the time period of datagram loss detection by the proxy (Tp) and (2) the time period to receive a packet containing feedback or acknowledgement from client (RTTpc/2) and later to get the retransmitted datagram payload delivered to the client (RTTpc/2), which together is one RTTpc; and the right side of the formula shows the sum of (1) the time period of packet loss detection by the server (Ts) and (2) the time period for the server to receive acknowledgements or feedback from the client in the end-to-end transmission (RTTpc/2+RTTsp/2). Note that the latter is the end-to-end traffic forwarding delay between the client and server.

(2) One end-to-end retransmission occurs, but local retransmission completes significantly before the end-to-end transmission: The proxy can complete one or more local retransmission (thus recovering the lost end-to-end packet(s)) in the time it takes for the server to recover a single end-to-end packet. This case implies a slight overhead, but the application can make faster forward progress.

(3) End-to-end retransmission occurs while local retransmission is still ongoing. The proxy cannot recover the lost end-to-end packet(s) earlier than the server. This can happen if a link on the path is down for some time. The gain of local retransmission is reduced and the overhead of re-ordering the dual retransmission (end-to-end and local ones) may be detrimental to the application.

In the first two scenarios, local retransmission provides benefits for the end-to-end flow, while in the last case, it may be detrimental to end-to-end flow (thus the application may experience worse performance) and should be avoided. Thus, regarding the decision of network condition at reference 308, the proxy may decide whether the network condition regarding the local retransmission and end-to-end retransmission is such that the local retransmission is efficient, and if so, goes to reference 310 (causing transmission of the QUIC datagram); otherwise goes to reference 312 (no local retransmission).

Note that the local retransmission mechanism at the proxy (including buffering and logic to cause local retransmission) may be implemented in a proxy application outside of the QUIC protocol implementation. In addition or in alternative, the local retransmission mechanism may be implemented as a part of the QUIC protocol implementation, and an application protocol interface (API) may be used between the proxy application and QUIC implementation, indicating which parameters to apply to the retransmission decision, based on information that is already available in the QUIC implementations, such as packet loss rate, RTT between client and proxy, spin-bit measurement of RTT between proxy and server.

Using the proxy-based retransmission mechanism, the transmission of QUIC datagrams to recover the lost end-to-end packets in the QUIC datagram forwarding segment may incur less per-packet overhead, and it avoids the head-of-line blocking that would incur if a QUIC stream-based service is used. Additionally, the transmission of QUIC datagrams for local recovery enables selective local retransmission that can be optimized based on delay measurements, characteristics of application/end-to-end traffic flow, and network conditions as discussed herein above. The selective local retransmission also reduces memory consumption on a proxy or peer network device at which local retransmission is performed, compared to end-to-end retransmission.

Note a proxy may implement the local retransmission without the support of a peer network device if the local retransmission is performed on the proxy only. The receiving peer network device that experiences the end-to-end packet loss (or QUIC datagram loss) does not need to know from where the retransmitted end-to-end packet is initiated (from the proxy or the transmitting peer network device). Such proxy-based local retransmission saves the resources that would be consumed when the end-to-end retransmission is initiated (which may trigger not only retransmission but also end-to-end congestion control).

The proxy-based local retransmission can be configured in a third Generation Partnership Project (3GPP) context. For example, a Policy and Charging Control (PCC) rule may be implemented for local retransmission. The next section discusses the relevant 3GPP context, using 5G reference architecture as a non-limiting example.

5G reference architecture

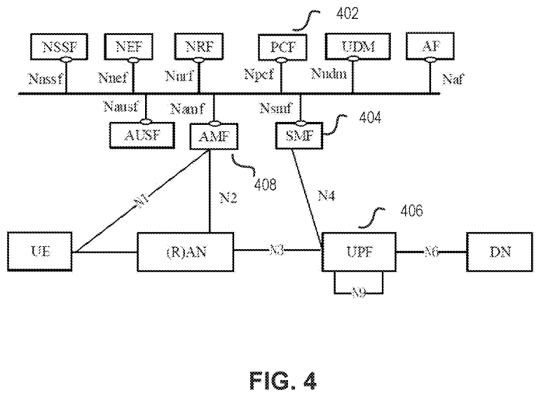

FIG. 4 illustrates the 5G reference architecture as defined by 3GPP (the third Generation Partnership Project). The relevant architectural aspects for embodiments of the invention may include one or more of the following blocks: Policy Control Function (PCF) 402, Session Management Function (SMF) 404, User Plane Function (UPF) 406, and Access and Mobility Management Function (AMF) 408.

### Policy Control Function (PCF)

The Policy Control Function (PCF) 402 supports a unified policy framework to govern the network behavior. Specifically, the PCF provides Policy and Charging Control (PCC) rules to the Policy and Charging Enforcement Function (PCEF), i.e., the SMF/UPF that enforces policy and charging decisions according to provisioned PCC rules.

### Session Management Function (SMF)

The Session Management Function (SMF) 404 supports different functionalities. Specifically, for this invention, SMF receives PCC rules from the PCF and configures the UPF accordingly.

### User Plane Function (UPF)

The User Plane Function (UPF) 406 supports handling of user plane traffic based on the rules received from the SMF; specifically, for this invention, packet inspection and different enforcement actions such as Quality of Service (QOS), charging, etc.

### Access and Mobility Management Function (AMF)

The Access and Mobility Management Function (AMF) 408 performs functionalities such as connection management, providing transport for session management (SM) messages between User equipment (UE) and SMF, and it may operate as a transparent proxy for routing SM messages.

While not showing in the reference architecture, a Unified Data Repository (UDR) is used in 5G to store and allow retrieval of policy data by PCF, store and allow retrieval of subscription data, and store and allow retrieval of application data such as packet flow descriptions (PFDs) for application detection, Application Function (AF) request information for multiple UEs.

Implement Policy and Charging Control (PCC) rule for local retransmission

One or more PCC rules may be implemented for local retransmission through a proxy. A PCC rule may include an application ID (e.g., example.com) and a traffic optimization service, “local retransmission.” This allows this functionality to be enabled both on a per application basis and on a per subscriber (or subscriber group) basis (e.g., only for a certain subscriber group like platinum/gold subscribers).

Additionally, as part of the PCC rule, a “local retransmission” profile can be conveyed, to define the conditions under which this new service will be enabled and the specific parameters, e.g., a specific packet loss rate threshold, a relative traffic forwarding delay (e.g., RTT) threshold or a specific retransmission rule. The semantics of the profile may be locally configured in the proxy entity at UPF. Note this profile might indicate when to enable the “local retransmission” traffic optimization service, based on network conditions.

Using the same scenario above where the peer network devices are a client and a server, and the client-proxy segment is the one forwarding QUIC datagrams (see FIGS. 1 and 2), the network conditions to be considered include the following:

(1) relative traffic forwarding delay (e.g., RTT). The “local retransmission” service is enabled when the proxy is close to the client (based on a proxy locally configured threshold value). Alternatively, absolute traffic forwarding delay for the proxy-server segment by itself might be considered.

(2) data (packet/datagram) loss rate. The “local retransmission” service is enabled when the loss rate is above a proxy locally configured threshold value. The loss rate can be obtained from the outer connection (e.g., the outer connection 132). It could also be combined with contextual awareness such as access network type, projected congestion, time of day, etc. The threshold value can be based on a combination of network utility and application needs.

(3) data (packet/datagram) rates, which may be the processing rate at the proxy or traffic forwarding rate at the links. As the buffering depends on the data rates, the cost of providing local retransmission increases with the data rates, and for some applications, the need for local retransmission diminishes with the increased rates.

The implementation of the PCC rules may be shown in an example. FIGS. 5A-5C illustrate enabling local retransmission service using a Policy and Charging Control (PCC) rule per some embodiments. The peer network devices are a client (e.g., a QUIC client) 502 (which can be a UE) and an application server (e.g., being implemented in a QUIC server) 514, and the UPF 506 implements the functionality of the proxy 104. The local retransmission discussed herein is to be implemented for a certain application (e.g., example.com) and the UPF 506 has COPE/MASQUE entities (see FIG. 1 related discussion) of the proxy 104. The local retransmission service may be provisioned as a QoS policy in the UDR on a per subscriber basis. In addition or in alternative, the local retransmission service may be pre-provisioned for a subscriber on a per global basis for the application.

At steps 1 and 2, where the Packet Flow Control Protocol (PFCP) procedure 592 is performed between UPF 506 and SMF 508, the existing mechanism may be extended to report UPF capabilities with a new capability (QUIC proxy). This would allow SMF 508 to know which UPF(s) 506 support this capability and thus can have an influence on UPF selection.

Specifically, at step 1 (reference 522), the PFCP association request with UPF capability enabled, indicating as QUIC user plane (QUICU), is sent from UPF 506 to SMF 508; and at step 2 (reference 524), SMF 508 responds with a PFCP association response, acknowledging that the UPF 506 supports the local retransmission capability.

Following the Packet Flow Control Protocol (PFCP) procedure 592, the next operations are for user's Protocol Data Unit (PDU) session establishment (reference 594), which includes steps 3 to 15.

At step 3 (reference 528), client 502 triggers PDU session establishment by means of sending a N1 PDU session establishment request to AMF 504. At step 4 (reference 530), AMF 504 selects an SMF instance based on the available SMF instances obtained from Network Repository Function (NRF) (or based on the configured SMF information in AMF 504) and triggers Nsmf PDU Session Create Request 530. Note the sequence diagram in FIGS. 5A-5C does not include all the signaling messages involved in the PDU Session Establishment procedure as they are known in the art.

At step 5 (reference 532), SMF 508 triggers Npcf_SMPolicyControl_Create Request message to retrieve SM policies for the user PDU session. Then at step 6 (reference 534), PCF 510 triggers Nudr_Query Request message to retrieve the policy data for this user's PDU session from UDR 512.

At step 7 (reference 536), UDR 512 answers with Nudr_Query Response message including the Subscriber Policy Data, which includes, for example, a flag indicating the need to use QUIC Proxy functionality for this PDU session and to enable local retransmission functionality.

At step 8 (reference 538), PCF 510 generates the corresponding one or more PCC rules for the enablement of the local retransmission functionality based on Subscriber Policy Data.

At step 9 (reference 540), PCF 510 triggers Npcf_SMPolicyControl_Create Response message including the PCC rules to be applied for the user PDU session. For example, a flag indicating the need to use QUIC Proxy functionality may be conveyed; and additionally, a PCC rule for a certain application (example.com) including the local retransmission functionality as QoS enforcement actions. Thus, the PCC rule is mapped to the application through the stored application ID.

Continuing the operations to FIG. 5B, at step 10 (reference 542), SMF 508 then selects a UPF 506 that supports QUIC Proxy including the local retransmission functionality.

At step 11 (reference 544), SMF 508 triggers PFCP Session Establishment Request message including a new QUIC Proxy Information Element (IE) (which indicates the need to activate the QUIC Proxy functionality at UPF 506 for this PFCP session) and also the corresponding rules. The rules may include one or more of Packet Detection Rules (PDRs), Forwarding Action Rules (FARs), QOS Enforcement Rules (QERs), Usage Reporting Rules (URRs), and Buffering Action Rules (BARs). In this example, there will be a PDR with Packet Detection Information (PDI) of type application with appId=example.com, and a corresponding FAR, QER, URR, and/or BAR. The QER may be to be expended to include a request for local retransmission in some embodiments.

At step 12 (reference 546), UPF 506 activates the QUIC Proxy functionality for this PFCP session, stores the PDRs/FARs/QERs/URRs/BARs and answers back to SMF with a successful PFCP Session Establishment Response message including the QUIC proxy IP address (e.g., the IP address of the proxy 104).

At step 13 (reference 548), SMF 508 answers the Nsmf PDU Session Create Request in Step 4 by means of sending a Nsmf PDU Session Create Response to AMF 504, including the QUIC Proxy IP address.

At step 14 (reference 550), AMF 504 answers the N1 PDU Session Establishment Request in Step 3 by means of sending a N1 PDU Session Establishment Response to client 502, including the QUIC Proxy IP address.

At step 15 (reference 552), client 502 stores the QUIC proxy IP address that will be used to handle any application sessions using QUIC as transport protocol during this user's PDU session. The QUIC proxy IP address allows client 502 to locate proxy 104 in some embodiments.

Continuing the operations to FIG. 5C, where application traffic 596 are forwarded in steps 16 to 20, where the application is example.com. At step 16 (reference 554), the user opens an application (example.com) using QUIC as transport protocol, and client 502 establishes an outer QUIC connection for exposure with the QUIC proxy based on the location information of proxy 104 (e.g., through the QUIC proxy IP address).

At step 17 (reference 556), as QUIC proxy functionality is activated for this user's PDU session and the application uses QUIC as transport protocol, the client application (example.com) triggers an outer QUIC connection with the QUIC proxy (the COPE/MASQUE entities) at UPF 506. This outer connection may be used to negotiate the COPE/MASQUE traffic management optimization features, specifically the support of the local retransmission functionality, for which the UE application client exposes different information (e.g., appId=example.com, data loss information, etc.) to the COPE/MASQUE entities through this outer QUIC connection.

At step 18 (reference 558), the inner QUIC connection between application client and application server is used to exchange application data (with datagram-based encapsulation).

At steps 19 and 20 (reference 560 and 562), UPF 506 (acting as a QUIC Proxy and implementing the COPE/MASQUE entities) retrieves the exposed information (appId=example.com, packet loss information, etc.) from the outer QUIC connection, classifies the inner QUIC connection traffic in the PDR (appId=example.com) and applies the corresponding enforcement actions (e.g., FAR, QER, URR, and/or BAR), specifically the local retransmission indicated in the QER. For example, if packet loss is detected, the COPE/MASQUE entities within the QUIC proxy (e.g., the proxy 104) will retransmit the buffered data towards the corresponding endpoint. As mentioned, the decision whether to buffer and retransmit packets for an end-to-end packet-based traffic flow can be determined by a combination of measurements of network conditions and policies related to the type of flow that is being proxied. The combination of measurements and the corresponding thresholds may be set as PCC rules (e.g., as extensions in the QoS information of the PCC rule) so that when a rule is satisfied, the proxy causes local retransmission.

Note while the operations described in steps 1 to 20 apply to enabling local retransmission in a 5G network architecture, embodiments of the invention are not so limited, and local retransmission in a proxied network may be enabled in other types of network architectures as well. For example, if the operations are applied to a 4G/LTE (Long-Term Evolution) network as well, PCF, SMF, UPF in the 5G network are to be replaced by Policy and Charging Rules Function (PCRF), packet data network (PDN) gateway (PGW) control plane function (PGW-C) or traffic detention function (TDF) control plane function (TDF-C), and PGW user plane function (PGW-U) or TDF user plane function (TDF-U) in the 4G/LTE network, respectively.

### Operation Flow of Some Embodiments

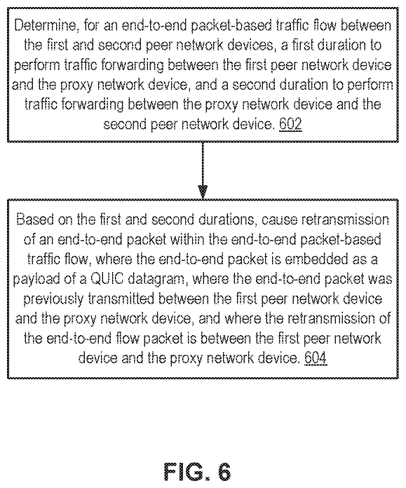

FIG. 6 is a flow diagram showing the operation flow of proxied datagram retransmission in a wireless network per some embodiments. The operations may be performed by a proxy such as the proxy 104, and it may be performed by the proxy in a 4G/5G wireless network or wireless network implemented according to another standard or a proprietary wireless network.

At reference 602, the proxy determines for an end-to-end packet-based traffic flow between the first and second peer network devices, a first duration to perform traffic forwarding between the first peer network device and the proxy network device, and a second duration to perform traffic forwarding between the proxy network device and the second peer network device. The first and second durations are the traffic forwarding delay between (1) the first peer network device and the proxy segment, and (2) the proxy and second peer network device segment, respectively. The determination of the traffic forwarding delay is discussed herein above, e.g., the sections relating to FIG. 2.

At reference 604, based on the first and second durations, the proxy causes retransmission of an end-to-end packet within the end-to-end packet-based traffic flow, where the end-to-end packet is embedded as a payload of a QUIC datagram, where the end-to-end packet was previously transmitted between the first peer network device and the proxy network device, and where the retransmission of the end-to-end packet is between the first peer network device and the proxy network device.

In some embodiments, the end-to-end packet is identified using an application identifier, and retransmission of the end-to-end packet is further based on a rule mapped to the application identifier. The local retransmission rules are discussed herein above, e.g., the sections relating to FIGS. 2, 3, and 5A-5C.

In some embodiments, the retransmission of the end-to-end packet is further based on severity of traffic loss between the first peer network device and the proxy network device. The severity may be based on the data (packet/datagram) loss rates and their corresponding thresholds for the end-to-end packet-based traffic flow in the segment as discussed herein above e.g., the sections relating to FIG. 3.

In some embodiments, the retransmission of the end-to-end packet is further based on a lapse of time since the end-to-end packet is determined to be in need of retransmission (e.g., proxy loss detection time, Tp) and a third duration to perform traffic forwarding between the first and second network devices (e.g., the end-to-end traffic forwarding delay that may be expressed as RTTpc/2+RTTsp/2 as discussed herein above). When the QUIC datagram containing the end-to-end packet was last transmitted and the end-to-end traffic forwarding delay are discussed herein above, e.g., the section relating to FIG. 3.

In some embodiments, the second duration is determined using one or more of: an initial handshake packet and a response to the initial handshake packet, a header bit in QUIC packets involved in the determination, an Internet control message protocol (ICMP) echo message transmitted, and a prior measurement. As discussed herein above (e.g., relating to FIG. 2), while in the segment of the first peer and proxy network devices, the traffic forwarding delay is easy to obtain since the QUIC layer can continuously estimate the delay, the segment of the proxy and second peer network devices may not forward QUIC datagrams, and other mechanisms are performed as discussed herein above.

In some embodiments, a user plane function (UPF) reports to a session management function (SMF) a capability of the retransmission based on the first and second durations, where the SMF selects the user plane function when retransmission is determined to be necessary. The operation of the reporting is described herein above, e.g., the discussion relating to reference 522.

In some embodiments, subscriber policy data stored in a unified data repository (UDR) indicates the capability of the retransmission based on the first and second durations for the end-to-end packet-based traffic flow, and a policy and charging control (PCC) rule is generated to enable the capability of the retransmission for the end-to-end packet-based traffic flow. These operations are described herein above, e.g., the discussion relating to references 536 and 538.

In some embodiments, the UPF receives a session establishment request message from the SMF, including a QoS enforcement rule (QER) that indicates a request for the capability of the retransmission, and the UPF provides location information of the proxy network device that supports the capability of the retransmission in response. These operations are described herein above, e.g., the discussion relating to references 544 and 546.

In some embodiments, the first peer network device identifies and establishes a connection with the proxy network device based on the location information of the proxy network device to provide the capability of the retransmission. These operations are described herein above, e.g., the discussion relating to references 554 and 556.

In some embodiments, the proxy network device is to cause retransmission of the end-to-end packet further based on the PCC rule. The operation is described herein above, e.g., the discussion relating to references 560 and 562.

### Network Environment

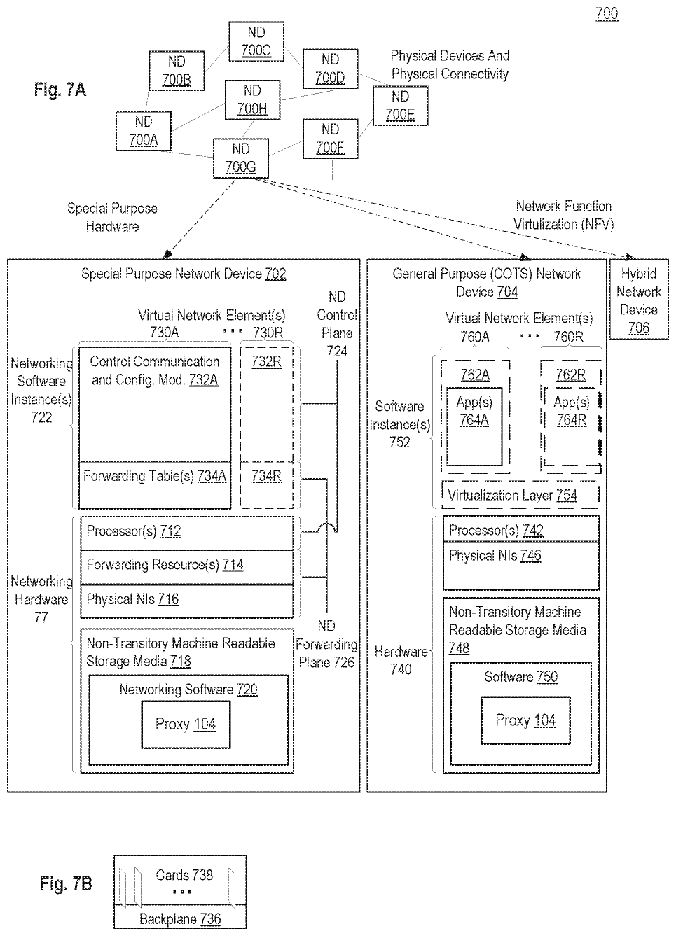

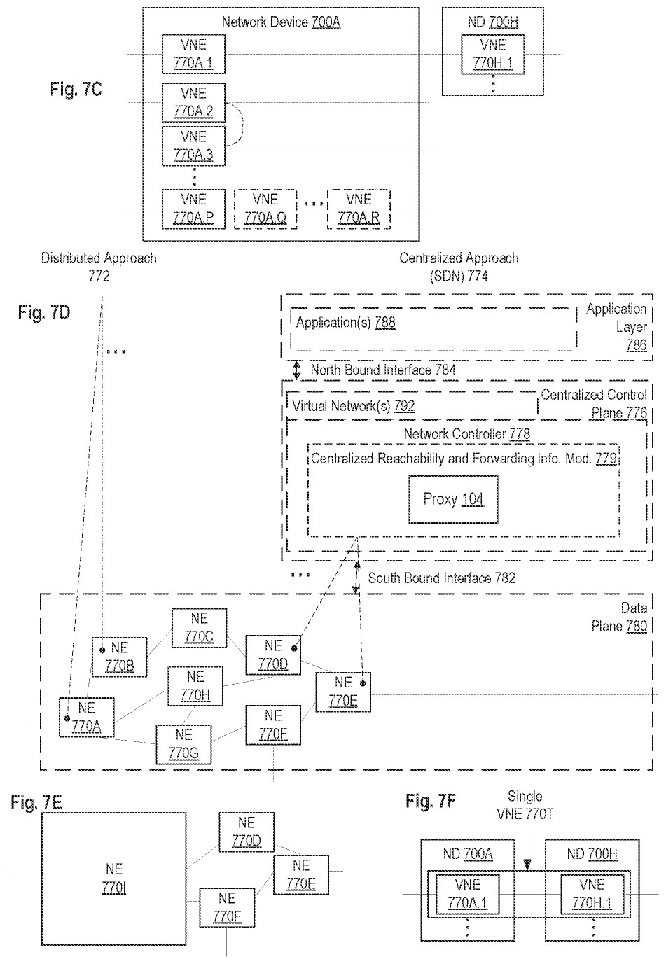

FIG. 7A illustrates connectivity between network devices (NDs) within an exemplary network, as well as three exemplary implementations of the NDs, according to some embodiments of the invention. FIG. 7A shows NDs 700A-H in network 700, and their connectivity by way of lines between 700A-700B, 700B-700C, 700C-700D, 700D-700E, 700E-700F, 700F-700G, and 700A-700G, as well as between 700H and each of 700A, 700C, 700D, and 700G. These NDs are physical devices, and the connectivity between these NDs can be wireless or wired (often referred to as a link). An additional line extending from NDs 700A, 700E, and 700F illustrates that these NDs act as ingress and egress points for the network (and thus, these NDs are sometimes referred to as edge NDs; while the other NDs may be called core NDs).

Two of the exemplary ND implementations in FIG. 7A are: 1) a special-purpose network device 702 that uses custom application-specific integrated circuits (ASICs) and a special-purpose operating system (OS); and 2) a general-purpose network device 704 that uses common off-the-shelf (COTS) processors and a standard OS.

The special-purpose network device 702 includes networking hardware 710 comprising a set of one or more processor(s) 712, forwarding resource(s) 714 (which typically include one or more ASICs and/or network processors), and physical network interfaces (NIs) 716 (through which network connections are made, such as those shown by the connectivity between NDs 700A-H), as well as non-transitory machine-readable storage media 718 having stored therein networking software 720. During operation, the networking software 720 may be executed by the networking hardware 710 to instantiate a set of one or more networking software instance(s) 722. Each of the networking software instance(s) 722, and that part of the networking hardware 710 that executes that network software instance (be it hardware dedicated to that networking software instance and/or time slices of hardware temporally shared by that networking software instance with others of the networking software instance(s) 722), form a separate virtual network element 730A-R. Each of the virtual network element(s) (VNEs) 730A-R includes a control communication and configuration module 732A-R (sometimes referred to as a local control module or control communication module) and forwarding table(s) 734A-R, such that a given virtual network element (e.g., 730A) includes the control communication and configuration module (e.g., 732A), a set of one or more forwarding table(s) (e.g., 734A), and that portion of the networking hardware 710 that executes the virtual network element (e.g., 730A). In some embodiments, the network software 720 includes the proxy 104, which performs operations discussed herein above.

The special-purpose network device 702 is often physically and/or logically considered to include: 1) a ND control plane 724 (sometimes referred to as a control plane) comprising the processor(s) 712 that execute the control communication and configuration module(s) 732A-R; and 2) a ND forwarding plane 726 (sometimes referred to as a forwarding plane, a data plane, or a media plane) comprising the forwarding resource(s) 714 that utilize the forwarding table(s) 734A-R and the physical NIs 716. By way of example, where the ND is a router (or is implementing routing functionality), the ND control plane 724 (the processor(s) 712 executing the control communication and configuration module(s) 732A-R) is typically responsible for participating in controlling how data (e.g., packets) is to be routed (e.g., the next hop for the data and the outgoing physical NI for that data) and storing that routing information in the forwarding table(s) 734A-R, and the ND forwarding plane 726 is responsible for receiving that data on the physical NIs 716 and forwarding that data out the appropriate ones of the physical NIs 716 based on the forwarding table(s) 734A-R.

FIG. 7B illustrates an exemplary way to implement the special-purpose network device 702 according to some embodiments of the invention. FIG. 7B shows a special-purpose network device including cards 738 (typically hot pluggable). While in some embodiments the cards 738 are of two types (one or more that operate as the ND forwarding plane 726 (sometimes called line cards), and one or more that operate to implement the ND control plane 724 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VOIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 736 (e.g., a first full mesh coupling the line cards and a second full mesh coupling all of the cards).

Returning to FIG. 7A, the general-purpose network device 704 includes hardware 740 comprising a set of one or more processor(s) 742 (which are often COTS processors) and physical NIs 746, as well as non-transitory machine-readable storage media 748 having stored therein software 750. During operation, the processor(s) 742 execute the software 750 to instantiate one or more sets of one or more applications 764A-R. While one embodiment does not implement virtualization, alternative embodiments may use different forms of virtualization. For example, in one such alternative embodiment the virtualization layer 754 represents the kernel of an operating system (or a shim executing on a base operating system) that allows for the creation of multiple instances 762A-R called software containers that may each be used to execute one (or more) of the sets of applications 764A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment the virtualization layer 754 represents a hypervisor (sometimes referred to as a virtual machine monitor (VMM)) or a hypervisor executing on top of a host operating system, and each of the sets of applications 764A-R is run on top of a guest operating system within an instance 762A-R called a virtual machine (which may in some cases be considered a tightly isolated form of software container) that is run on top of the hypervisor—the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 740, directly on a hypervisor (in which case the unikernel is sometimes described as running within a LibOS virtual machine), or in a software container, embodiments can be implemented fully with unikernels running directly on a hypervisor represented by virtualization layer 754, unikernels running within software containers represented by instances 762A-R, or as a combination of unikernels and the above-described techniques (e.g., unikernels and virtual machines both run directly on a hypervisor, unikernels and sets of applications that are run in different software containers). In some embodiments, the network software 750 includes the proxy 104, which performs operations discussed herein above.

The instantiation of the one or more sets of one or more applications 764A-R, as well as virtualization if implemented, are collectively referred to as software instance(s) 752. Each set of applications 764A-R, corresponding virtualization construct (e.g., instance 762A-R) if implemented, and that part of the hardware 740 that executes them (be it hardware dedicated to that execution and/or time slices of hardware temporally shared), forms a separate virtual network element(s) 760A-R.

The virtual network element(s) 760A-R perform similar functionality to the virtual network element(s) 730A-R-e.g., similar to the control communication and configuration module(s) 732A and forwarding table(s) 734A (this virtualization of the hardware 740 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments of the invention are illustrated with each instance 762A-R corresponding to one VNE 760A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 762A-R to VNEs also apply to embodiments where such a finer level of granularity and/or unikernels are used.

In certain embodiments, the virtualization layer 754 includes a virtual switch that provides similar forwarding services as a physical Ethernet switch. Specifically, this virtual switch forwards traffic between instances 762A-R and the physical NI(s) 746, as well as optionally between the instances 762A-R; in addition, this virtual switch may enforce network isolation between the VNEs 760A-R that by policy are not permitted to communicate with each other (e.g., by honoring virtual local area networks (VLANs)).

The third exemplary ND implementation in FIG. 7A is a hybrid network device 706, which includes both custom ASICs/special-purpose OS and COTS processors/standard OS in a single ND or a single card within an ND. In certain embodiments of such a hybrid network device, a platform VM (i.e., a VM that implements the functionality of the special-purpose network device 702) could provide for para-virtualization to the networking hardware present in the hybrid network device 706.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 730A-R, VNEs 760A-R, and those in the hybrid network device 706) receives data on the physical NIs (e.g., 716, 746) and forwards that data out the appropriate ones of the physical NIs (e.g., 716, 746). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

FIG. 7C illustrates various exemplary ways in which VNEs may be coupled according to some embodiments of the invention. FIG. 7C shows VNEs 770A. 1-770A.P (and optionally VNEs 770A.Q-770A.R) implemented in ND 700A and VNE 770H.1 in ND 700H. In FIG. 7C, VNEs 770A.1-P are separate from each other in the sense that they can receive packets from outside ND 700A and forward packets outside of ND 700A; VNE 770A.1 is coupled with VNE 770H.1, and thus they communicate packets between their respective NDs; VNE 770A.2-770A.3 may optionally forward packets between themselves without forwarding them outside of the ND 700A; and VNE 770A.P may optionally be the first in a chain of VNEs that includes VNE 770A.Q followed by VNE 770A.R (this is sometimes referred to as dynamic service chaining, where each of the VNEs in the series of VNEs provides a different service—e.g., one or more layer 4-7 network services). While FIG. 7C illustrates various exemplary relationships between the VNEs, alternative embodiments may support other relationships (e.g., more/fewer VNEs, more/fewer dynamic service chains, multiple different dynamic service chains with some common VNEs and some different VNEs).

The NDs of FIG. 7A, for example, may form part of the Internet or a private network; and other electronic devices (not shown; such as end user devices including workstations, laptops, netbooks, tablets, palm tops, mobile phones, smartphones, phablets, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 7A may also host one or more such servers (e.g., in the case of the general purpose network device 704, one or more of the software instances 762A-R may operate as servers; the same would be true for the hybrid network device 706; in the case of the special-purpose network device 702, one or more such servers could also be run on a virtualization layer executed by the processor(s) 712); in which case the servers are said to be co-located with the VNEs of that ND.

A virtual network is a logical abstraction of a physical network (such as that in FIG. 7A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network-originated attacks, to avoid malformed route announcements), and management capabilities (e.g., full detection and processing).

FIG. 7D illustrates a network with a single network element on each of the NDs of FIG. 7A, and within this straightforward approach contrasts a traditional distributed approach (commonly used by traditional routers) with a centralized approach for maintaining reachability and forwarding information (also called network control), according to some embodiments of the invention. Specifically, FIG. 7D illustrates network elements (NEs) 770A-H with the same connectivity as the NDs 700A-H of FIG. 7A.

FIG. 7D illustrates that the distributed approach 772 distributes responsibility for generating the reachability and forwarding information across the NEs 770A-H; in other words, the process of neighbor discovery and topology discovery is distributed.

For example, where the special-purpose network device 702 is used, the control communication and configuration module(s) 732A-R of the ND control plane 724 typically include a reachability and forwarding information module to implement one or more routing protocols (e.g., an exterior gateway protocol such as Border Gateway Protocol (BGP), Interior Gateway Protocol(s) (IGP) (e.g., Open Shortest Path First (OSPF), Intermediate System to Intermediate System (IS-IS), Routing Information Protocol (RIP), Label Distribution Protocol (LDP), Resource Reservation Protocol (RSVP) (including RSVP-Traffic Engineering (TE): Extensions to RSVP for LSP Tunnels and Generalized Multi-Protocol Label Switching (GMPLS) Signaling RSVP-TE)) that communicate with other NEs to exchange routes, and then selects those routes based on one or more routing metrics. Thus, the NEs 770A-H (e.g., the processor(s) 712 executing the control communication and configuration module(s) 732A-R) perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane 724. The ND control plane 724 programs the ND forwarding plane 726 with information (e.g., adjacency and route information) based on the routing structure(s). For example, the ND control plane 724 programs the adjacency and route information into one or more forwarding table(s) 734A-R (e.g., Forwarding Information Base (FIB), Label Forwarding Information Base (LFIB), and one or more adjacency structures) on the ND forwarding plane 726. For layer 2 forwarding, the ND can store one or more bridging tables that are used to forward data based on the layer 2 information in that data. While the above example uses the special-purpose network device 702, the same distributed approach 772 can be implemented on the general-purpose network device 704 and the hybrid network device 706.

FIG. 7D illustrates that a centralized approach 774 (also known as software defined networking (SDN)) that decouples the system that makes decisions about where traffic is sent from the underlying systems that forwards traffic to the selected destination. The illustrated centralized approach 774 has the responsibility for the generation of reachability and forwarding information in a centralized control plane 776 (sometimes referred to as a SDN control module, controller, network controller, OpenFlow controller, SDN controller, control plane node, network virtualization authority, or management control entity), and thus the process of neighbor discovery and topology discovery is centralized. The centralized control plane 776 has a south bound interface 782 with a data plane 780 (sometime referred to the infrastructure layer, network forwarding plane, or forwarding plane (which should not be confused with a ND forwarding plane)) that includes the NEs 770A-H (sometimes referred to as switches, forwarding elements, data plane elements, or nodes). The centralized control plane 776 includes a network controller 778, which includes a centralized reachability and forwarding information module 779 that determines the reachability within the network and distributes the forwarding information to the NEs 770A-H of the data plane 780 over the south bound interface 782 (which may use the OpenFlow protocol). Thus, the network intelligence is centralized in the centralized control plane 776 executing on electronic devices that are typically separate from the NDs. In some embodiments, the network controller 778 includes the proxy 104, which performs operations discussed herein above.

For example, where the special-purpose network device 702 is used in the data plane 780, each of the control communication and configuration module(s) 732A-R of the ND control plane 724 typically include a control agent that provides the VNE side of the south bound interface 782. In this case, the ND control plane 724 (the processor(s) 712 executing the control communication and configuration module(s) 732A-R) performs its responsibility for participating in controlling how data (e.g., packets) is to be routed (e.g., the next hop for the data and the outgoing physical NI for that data) through the control agent communicating with the centralized control plane 776 to receive the forwarding information (and in some cases, the reachability information) from the centralized reachability and forwarding information module 779 (it should be understood that in some embodiments of the invention, the control communication and configuration module(s) 732A-R, in addition to communicating with the centralized control plane 776, may also play some role in determining reachability and/or calculating forwarding information-albeit less so than in the case of a distributed approach; such embodiments are generally considered to fall under the centralized approach 774, but may also be considered a hybrid approach).

While the above example uses the special-purpose network device 702, the same centralized approach 774 can be implemented with the general purpose network device 704 (e.g., each of the VNE 760A-R performs its responsibility for controlling how data (e.g., packets) is to be routed (e.g., the next hop for the data and the outgoing physical NI for that data) by communicating with the centralized control plane 776 to receive the forwarding information (and in some cases, the reachability information) from the centralized reachability and forwarding information module 779; it should be understood that in some embodiments of the invention, the VNEs 760A-R, in addition to communicating with the centralized control plane 776, may also play some role in determining reachability and/or calculating forwarding information-albeit less so than in the case of a distributed approach) and the hybrid network device 706. In fact, the use of SDN techniques can enhance the NFV techniques typically used in the general-purpose network device 704 or hybrid network device 706 implementations as NFV is able to support SDN by providing an infrastructure upon which the SDN software can be run, and NFV and SDN both aim to make use of commodity server hardware and physical switches.

FIG. 7D also shows that the centralized control plane 776 has a north bound interface 784 to an application layer 786, in which resides application(s) 788. The centralized control plane 776 has the ability to form virtual networks 792 (sometimes referred to as a logical forwarding plane, network services, or overlay networks (with the NEs 770A-H of the data plane 780 being the underlay network)) for the application(s) 788. Thus, the centralized control plane 776 maintains a global view of all NDs and configured NEs/VNEs, and it maps the virtual networks to the underlying NDs efficiently (including maintaining these mappings as the physical network changes either through hardware (ND, link, or ND component) failure, addition, or removal).

While FIG. 7D shows the distributed approach 772 separate from the centralized approach 774, the effort of network control may be distributed differently or the two combined in certain embodiments of the invention. For example: 1) embodiments may generally use the centralized approach (SDN) 774, but have certain functions delegated to the NEs (e.g., the distributed approach may be used to implement one or more of fault monitoring, performance monitoring, protection switching, and primitives for neighbor and/or topology discovery); or 2) embodiments of the invention may perform neighbor discovery and topology discovery via both the centralized control plane and the distributed protocols, and the results compared to raise exceptions where they do not agree. Such embodiments are generally considered to fall under the centralized approach 774, but they may also be considered a hybrid approach.

While FIG. 7D illustrates the simple case where each of the NDs 700A-H implements a single NE 770A-H, it should be understood that the network control approaches described with reference to FIG. 7D also work for networks where one or more of the NDs 700A-H implement multiple VNEs (e.g., VNEs 730A-R, VNEs 760A-R, those in the hybrid network device 706). Alternatively or in addition, the network controller 778 may also emulate the implementation of multiple VNEs in a single ND. Specifically, instead of (or in addition to) implementing multiple VNEs in a single ND, the network controller 778 may present the implementation of a VNE/NE in a single ND as multiple VNEs in the virtual networks 792 (all in the same one of the virtual network(s) 792, each in different ones of the virtual network(s) 792, or some combination). For example, the network controller 778 may cause an ND to implement a single VNE (a NE) in the underlay network, and then logically divide up the resources of that NE within the centralized control plane 776 to present different VNEs in the virtual network(s) 792 (where these different VNEs in the overlay networks are sharing the resources of the single VNE/NE implementation on the ND in the underlay network).

On the other hand, FIGS. 7E and 7F, respectively illustrate exemplary abstractions of NEs and VNEs that the network controller 778 may present as part of different ones of the virtual networks 792. FIG. 7E illustrates the simple case of where each of the NDs 700A-H implements a single NE 770A-H (see FIG. 7D), but the centralized control plane 776 has abstracted multiple of the NEs in different NDs (the NEs 770A-C and G-H) into (to represent) a single NE 770I in one of the virtual network(s) 792 of FIG. 7D, according to some embodiments of the invention. FIG. 7E shows that in this virtual network, the NE 770I is coupled to NE 770D and 770F, which are both still coupled to NE 770E.

FIG. 7F illustrates a case where multiple VNEs (VNE 770A.1 and VNE 770H.1) are implemented on different NDs (ND 700A and ND 700H) and are coupled to each other, and where the centralized control plane 776 has abstracted these multiple VNEs such that they appear as a single VNE 770T within one of the virtual networks 792 of FIG. 7D, according to some embodiments of the invention. Thus, the abstraction of a NE or VNE can span multiple NDs.

While some embodiments of the invention implement the centralized control plane 776 as a single entity (e.g., a single instance of software running on a single electronic device), alternative embodiments may spread the functionality across multiple entities for redundancy and/or scalability purposes (e.g., multiple instances of software running on different electronic devices).

Similar to the network device implementations, the electronic device(s) running the centralized control plane 776, and thus the network controller 778 including the centralized reachability and forwarding information module 779, may be implemented a variety of ways (e.g., a special purpose device, a general-purpose (e.g., COTS) device, or hybrid device). These electronic device(s) would similarly include processor(s), a set of one or more physical NIs, and a non-transitory machine-readable storage medium having stored thereon the centralized control plane software.

### Terms

A network interface (NI) may be physical or virtual; and in the context of IP, an interface address is an IP address assigned to a NI, being it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

Certain NDs (e.g., certain edge NDs) use a hierarchy of circuits. The leaf nodes of the hierarchy of circuits are subscriber circuits. The subscriber circuits have parent circuits in the hierarchy that typically represent aggregations of multiple subscriber circuits, and thus the network segments and elements used to provide access network connectivity of those end user devices to the ND. These parent circuits may represent physical or logical aggregations of subscriber circuits (e.g., a virtual local area network (VLAN), a permanent virtual circuit (PVC) (e.g., for Asynchronous Transfer Mode (ATM)), a circuit-group, a channel, a pseudo-wire, a physical NI of the ND, and a link aggregation group). A circuit-group is a virtual construct that allows various sets of circuits to be grouped together for configuration purposes, for example aggregate rate control. A pseudo-wire is an emulation of a layer 2 point-to-point connection-oriented service. A link aggregation group is a virtual construct that merges multiple physical NIs for purposes of bandwidth aggregation and redundancy. Thus, the parent circuits physically or logically encapsulate the subscriber circuits.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other. A “set,” as used herein, refers to any positive whole number of items including one item.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

The term “node” can be a network node/device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video). Examples of network nodes also include NodeB, base station (BS), multi-standard radio (MSR) radio node such as MSR BS, eNodeB, gNodeB. MeNB, SeNB, integrated access backhaul (IAB) node, network controller, radio network controller (RNC), base station controller (BSC), relay, donor node controlling relay, base transceiver station (BTS), Central Unit (e.g., in a gNB), Distributed Unit (e.g., in a gNB), Baseband Unit, Centralized Baseband, C-RAN, access point (AP), transmission points, transmission nodes, RRU, RRH, nodes in distributed antenna system (DAS), core network node (e.g., MSC, MME, etc.), O&M, OSS, SON, positioning node (e.g., E-SMLC), etc.

Another example of a node is an end-user device, which is a non-limiting term and refers to any type of wireless and wireline device communicating with a network node and/or with another UE in a cellular/mobile/wireline communication system. Examples of end-user device are target device, device to device (D2D) user equipment (UE), vehicular to vehicular (V2V), machine type UE, MTC UE or UE capable of machine to machine (M2M) communication, PDA, Tablet, mobile terminals, smart phone, laptop embedded equipment (LEE), laptop mounted equipment (LME), Internet-of-Things (IoTs) electronic devices, USB dongles, etc.

A node may be an endpoint node of a traffic flow (also simply referred to as “flow”) or an intermediate node (also referred to as an on-path node) of the traffic flow. The endpoint node of the traffic flow may be a source or destination node (or sender and receiver node, respectively) of the traffic flow, which is routed from the source node, passing through the intermediate node, and to the destination node. A flow may be defined as a set of packets whose headers match a given pattern of bits. A flow may be identified by a set of attributes embedded to one or more packets of the flow. An exemplary set of attributes includes a 5-tuple (source and destination IP addresses, a protocol type, source and destination TCP/UDP ports).

### Alternative Embodiments

While the block and flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

1. A method performed by a proxy network device that is on a path between a first peer network device and a second peer network device, the method comprising:
determining, for an end-to-end packet-based traffic flow between the first and second peer network devices, a first duration to perform traffic forwarding between the first peer network device and the proxy network device, and a second duration to perform traffic forwarding between the proxy network device and the second peer network device; and
based on the first and second durations, causing retransmission of an end-to-end packet within the end-to-end packet-based traffic flow, wherein the end-to-end packet is embedded as a payload of a QUIC datagram, where the end-to-end packet was previously transmitted between the first peer network device and the proxy network device, and wherein the retransmission of the end-to-end packet is between the first peer network device and the proxy network device.

2. The method of claim 1, wherein the end-to-end packet is identified using an application identifier, and wherein retransmission of the end-to-end packet is further based on a rule mapped to the application identifier.

3. The method of claim 1, wherein the retransmission of the end-to-end packet is further based on severity of traffic loss between the first peer network device and the proxy network device.

4. The method of claim 1, wherein the retransmission of the end-to-end packet is further based on a lapse of time since the end-to-end packet is determined to be in need of retransmission and a third duration to perform traffic forwarding between the first and second peer network devices.

5. The method of claim 1, wherein the second duration is determined using one or more of: an initial handshake packet and a response to the initial handshake packet, a header bit in QUIC packets involved in the determination of the second duration, an Internet control message protocol (ICMP) echo message transmitted, and a prior measurement.

6. The method of claim 1, wherein a user plane function (UPF) reports to a session management function (SMF) a capability of the retransmission based on the first and second durations, wherein the SMF selects the user plane function when retransmission is determined to be necessary.

7. The method of claim 6, wherein subscriber policy data stored in a unified data repository (UDR) indicates the capability of the retransmission based on the first and second durations for the end-to-end packet-based traffic flow, and wherein a policy and charging control (PCC) rule is generated to enable the capability of the retransmission for the end-to-end packet-based traffic flow.

8. The method of claim 7, wherein the UPF receives a session establishment request message from the SMF, including a QoS enforcement rule (QER) that indicates a request for the capability of the retransmission, and wherein the UPF provides location information of the proxy network device that supports the capability of the retransmission in response.

9. The method of claim 8, wherein the first peer network device identifies and establishes a connection with the proxy network device based on the location information of the proxy network device to provide the capability of the retransmission.

10. The method of claim 7, wherein the proxy network device causes retransmission of the end-to-end packet further based on the PCC rule.

11. A proxy network device to be implemented on a path between a first peer network device and a second peer network device, the proxy network device comprising:
a processor and machine-readable storage medium coupled to the processor, wherein the machine-readable storage medium stores instructions, which when executed by the processor, causes the processor to perform the steps of:
determining, for an end-to-end packet-based traffic flow between the first and second peer network devices, a first duration to perform traffic forwarding between the first peer network device and the proxy network device, and a second duration to perform traffic forwarding between the proxy network device and the second peer network device; and
based on the first and second durations, causing retransmission of an end-to-end packet within the end-to-end packet-based traffic flow, wherein the end-to-end packet is embedded as a payload of a QUIC datagram, wherein the end-to-end packet was previously transmitted between the first peer network device and the proxy network device, and wherein the retransmission of the end-to-end packet is between the first peer network device and the proxy network device.

12. The proxy network device of claim 11, wherein the end-to-end packet is identified using an application identifier, and wherein retransmission of the end-to-end packet is further based on a rule mapped to the application identifier.

13. The proxy network device of claim 11, wherein the retransmission of the end-to-end packet is further based on severity of traffic loss between the first peer network device and the proxy network device.

14. The proxy network device of claim 11, wherein the second duration is determined using one or more of: an initial handshake packet and a response to the initial handshake packet, a header bit in QUIC packets involved in the determination of the second duration, an Internet control message protocol (ICMP) echo message transmitted, and a prior measurement.

15. The proxy network device of claim 11, wherein a user plane function (UPF) reports to a session management function (SMF) a capability of the retransmission based on the first and second durations, wherein the SMF selects the user plane function when retransmission is determined to be necessary.

16. The proxy network device of claim 15, wherein subscriber policy data stored in a unified data repository (UDR) indicates the capability of the retransmission based on the first and second durations for the end-to-end packet-based traffic flow, and wherein a policy and charging control (PCC) rule is generated to enable the capability of the retransmission for the end-to-end packet-based traffic flow.

17. The proxy network device of claim 16, wherein the UPF receives a session establishment request message from the SMF, including a QoS enforcement rule (QER) that indicates a request for the capability of the retransmission, and wherein the UPF provides location information of the proxy network device that supports the capability of the retransmission in response.

18. The proxy network device of claim 16, wherein causing retransmission of the end-to-end packet is further based on the PCC rule.

19. A machine-readable storage medium coupled to a processor, wherein the machine-readable storage medium stores instructions, which when executed by the processor, cause:
determining, for an end-to-end packet-based traffic flow between a first peer network device and a second peer network device, a first duration to perform traffic forwarding between the first peer network device and a proxy network device, and a second duration to perform traffic forwarding between the proxy network device and the second peer network device; and
based on the first and second durations, causing retransmission of an end-to-end packet within the end-to-end packet-based traffic flow, wherein the end-to-end packet is embedded as a payload of a QUIC datagram, wherein the end-to-end packet was previously transmitted between the first peer network device and the proxy network device, and wherein the retransmission of the end-to-end packet is between the first peer network device and the proxy network device.

20. The machine-readable storage medium of claim 19, wherein the end-to-end packet is identified using an application identifier, and wherein retransmission of the end-to-end packet is further based on a rule mapped to the application identifier.
